(19) United States
(12) Patent Application Publication
(10) Pub. No.: US 2007/0109275 A1
(43) Pub. Date: May 17, 2007

(54) METHOD FOR CONTROLLING A TOUCH SCREEN USER INTERFACE AND DEVICE THEREOF

(76) Inventor: Chen-Ting Chuang, Ping-Tung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/550,807

(22) Filed: Oct. 19, 2006

Related U.S. Application Data
(60) Provisional application No. 60/597,189, filed on Nov. 16, 2005.

(51) Int. Cl. G09G 5/00

(52) U.S. Cl. 345/173

(57) ABSTRACT

A method for controlling a touch screen user interface is disclosed. The method includes receiving a plurality of touch screen events; selectively discarding at least one of successive discardable touch screen events; translating non-discarded touch screen events into a plurality of screen update commands; and processing the screen update commands to control the touch screen user interface.

### CROSS REFERENCE TO RELATED APPLICATIONS

This application claims the benefit of U.S. Provisional Application No. 60/597,189, which was filed on Nov. 16, 2005 and is included herein by reference.

### BACKGROUND

The present invention relates generally to a method for controlling a touch screen and the related device, and more specifically, to a method for controlling a touch screen having a high level of responsiveness and the related device.

A touch screen functions as a display screen and a user input mechanism. Unlike non-touch display devices, touch screens both display and receive the user inputs. The touch screen's combination of display device and user input device offers significant utility to its users. Continued development aimed at improving the existing touch screen technology is essential. Partly because touch screen are being utilized by a greater number of devices, including by not limited to: personal digital assistants (PDAs), mobile phones, and many other embedded devices.

The touch screen can detect the position of an object that is placed on its surface, for example, a fingertip, a pen tip, or some other similar object. Whichever means is utilized for interaction with the touch screen, and it is essential that the users are provided with instantaneous response to their input. Unfortunately, not all devices that utilize touch screens are capable of providing the processing power necessary for such a responsive user experience.

For the description here, the object used to manipulate and interact with the touch screen is called a pen. The pen is designed for use with the touch screen by way of interacting with the user interface as displayed on the touch screen. As user interacts with the user interface using the pen, the user will tap with the pen tip. The touch screen recognizes this action. These taps are called pen events.

Pen events can be classified into three groups but are not limited to only these groups: a pen-down event, a pen-move event, and a pen-up event. The pen-down event is the name given to the action when the user takes the pen and taps it onto the touch screen. In other words, if the touch screen pen is a pencil, and if the touch screen is a sheet of paper, then the pen-down event is the same as tapping the paper with the tip of the pencil. The pen-move event indicates that the pen is moving on the touch screen. For example, the user has placed the pen tip onto the touch screen but rather than removing it (i.e., placing the pen on the touch screen and then directly thereafter removing it is of course a pen-down event) the user moves the pen tip across the surface of the touch screen. Hereinafter, please note that pen and pen tip are the both used to describe and refer to the tip of the touch screen pen. Finally, the third group of pen events is called pen-up events. The pen-up event occurs when the user lifts the pen from the surface of the touch screen. The operation of pen interaction with touch screens is well known to a person of average skill in the pertinent art, therefore, additional details are omitted for the sake of brevity.

In the prior art, the user's pen events are recorded, for example, in a queue. The queue can be called a pen event queue. The queue is a first-in-first-out queue (FIFO) thereby pen events are processed in the order that they are received. An event controller handles the processing of pen events. For example, in the prior art, each pen event must be converted or translated into actions corresponding to the user's interaction with the user interface that is displayed on the touch screen.

At certain times, the user will have a perception that the responsiveness of the touch screen is less than adequate. In other words, the touch screen may response to the user's input in a sluggish fashion. Perhaps the user is very efficient and fast with the pen and the user interface, or maybe the processing power that is available for processing the pen events is less than that which can keep pace with the user's pen movements. Whatever the case, the prior art techniques for handling pen events often provide the user with a sluggish user interface experience. This is at best an inconvenience and more often an impediment to the user's efficiency.

Therefore, it is apparent that new and improved methods and devices for the handling of pen events are needed to solve the above-mentioned problems.

### SUMMARY

It is therefore one of the primary objectives of the claimed invention to provide a method for controlling a touch screen user interface and the related apparatus thereof to solve the aforementioned problems.

According to an embodiment of the claimed invention, a method for controlling a touch screen user interface is disclosed. The method includes receiving a plurality of touch screen events; selectively discarding at least one of successive discardable touch screen events; translating non-discarded touch screen events into a plurality of screen update commands; and processing the screen update commands to control the touch screen user interface.

According to another embodiment of the claimed invention, a method for controlling a touch screen user interface is disclosed. The method includes receiving a plurality of touch screen events; translating the touch screen events into a plurality of screen update commands, and assigning each of the screen update commands a priority according to a user interface element displayed on the touch screen user interface; and processing the screen update commands to control the touch screen user interface according to corresponding priorities.

According to another embodiment of the claimed invention, a device for controlling a touch screen user interface is disclosed. The device comprises: an event converter for receiving a plurality of touch screen events and selectively discarding at least one of successive discardable touch screen events; a memory, coupled to the event converter, for buffering non-discarded touch screen events outputted from the event converter; an event controller, coupled to the memory, for translating the non-discarded touch screen events into a plurality of screen update commands, and processing the screen update commands to control the touch screen user interface.

According to another embodiment of the claimed invention, a device for controlling a touch screen user interface is disclosed. The device comprises: an event converter for receiving a plurality of touch screen events; a memory, coupled to the event converter, for buffering the touch screen events outputted from the event converter; and an event controller, coupled to the memory, for selectively discarding at least one of successive discardable touch screen events received from the memory, translating non-discarded touch screen events into a plurality of screen update commands, and processing the screen update commands to control the touch screen user interface.

According to another embodiment of the claimed invention, a device for controlling a touch screen user interface is disclosed. The device comprises: an event converter, for receiving a plurality of touch screen events; a memory, coupled to the event converter, for buffering the touch screen events; and an event controller, coupled to the memory, for translating the touch screen events into a plurality of screen update commands, assigning each of the screen update commands a priority according to a user interface element displayed on the touch screen user interface, and processing the screen update commands to control the touch screen user interface according to corresponding priorities.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of an embodiment of a device for controlling a touch screen user interface according to the present invention.

FIG. 2 is a flowchart showing a method for selectively discarding pen-move events according to an embodiment of the present invention.

FIG. 3 is a flowchart showing a method for assigning priorities to screen update commands according to an embodiment of the present invention.

FIG. 4 is a diagram illustrating a scroll bar and a display area controlled by the scroll bar.

FIG. 5 is a flowchart showing a method for delaying screen update commands based on priority according to an embodiment of the present invention.

FIG. 6 is a flowchart showing a method for aborting existing discardable screen update commands based on new screen update commands generated in response to the same interaction with the touch screen user interface (i.e., scrolling the same scroll bar continuously) according to an embodiment of the present invention.

FIG. 7 is a flowchart showing a method for aborting existing screen update commands based on proximity according to an embodiment of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”The terms “couple” and “couples” are intended to mean either an indirect or a direct electrical connection. Thus, if a first device couples to a second device, that connection may be through a direct electrical connection, or through an indirect electrical connection via other devices and connections, or through software interface such as function, variable, or message.

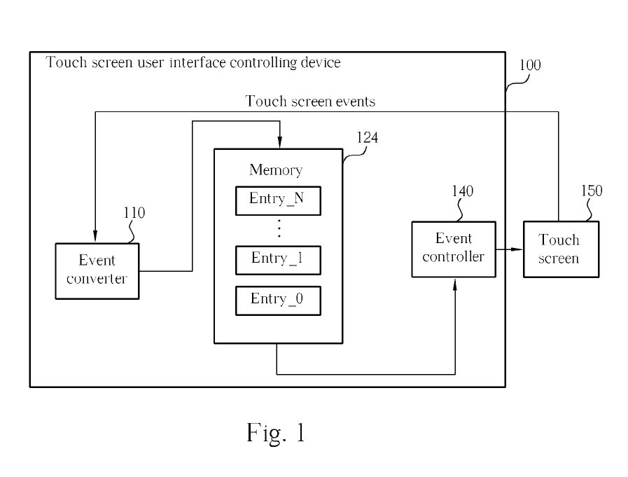

Please refer to FIG. 1. FIG. 1 is a simplified block diagram of an embodiment of a device for controlling a touch screen user interface according to the present disclosure. As shown in FIG. 1, a touch screen user interface controlling device 100 comprises an event converter 110, a memory 124, and an event controller 140. In one embodiment, the memory 124 required by the touch screen interface controlling device 100 for buffering touch screen events is implemented using a queue containing a plurality of entries for buffering data; however, this is not meant to be a limitation of the present invention.

The touch screen user interface controlling device 100 accepts input (i.e., touch screen events) from a touch screen 150 accessible to users and later provides output to control display of the touch screen 150. As shown in FIG. 1, the touch screen user interface controlling device 100 is positioned outside the touch screen 150. However, the touch screen user interface controlling device 100 can be disposed within the touch screen 150 in another embodiment of the present invention.

The following is a more detailed description of the operation of the touch screen user interface controlling device 100 and its components. The event converter 110 is coupled to the touch screen 150, and is designed to receive touch screen events (e.g., pen events including pen-up events, pen-down events, and pen-move events as mentioned above) and then stores the received touch screen events into the memory 124. In this embodiment, the touch screen event is defined to be an event triggered due to interaction with the touch screen 150. However, for better understanding of the disclosed event processing scheme, this term “pen event” is adopted hereinafter. It should be noted that a person skilled in this art can readily realize that the present invention is not limited to a field of processing events triggered by pens after reading the following disclosure.

In one embodiment of the present invention, the memory 124 is preferably implemented using a queue, and the event converter 110 stores the incoming pen events into respective entries Entry_0, Entry_1, . . . , Entry_N sequentially, where a pen event buffered in Entry_0 is outputted before a next pen event buffered in Entry_1 according to a well-known first-in first-out data buffering scheme. In other words, the event controller 140 retrieves pen events buffered in Entry_0, Entry_1, . . . , Entry_N sequentially, and controls the touch screen 150 by processing the pen events retrieved from the memory 124. In this case, the event converter 110, for example, supports an event discarding mechanism to alleviate processing load of the event controller 140, thereby boosting response speed of the touch screen 150. That is, the event converter 110 is capable of selectively discarding at least one of successive discardable pen events to be buffered in entries of the memory 124.

In another embodiment, the event controller 140 can be designed, for example, to support an event discarding mechanism to thereby reduce the processing load thereof. That is, the event controller 140 selectively discards at least one of discardable pen events received from the memory 124 and then processes the un-discarded pen events to control the touch screen user interface that is displayed on the touch screen 150. It should be noted that in a preferred embodiment of the present invention the pen event discarding is executed for overriding an old touch screen generated in response to a user interaction by a new touch screen event generated in response to the same user interaction if these touch screen events are independent events generated by the event converter 110. Taking the scroll bar scrolling for example, if the user quickly scrolls the scroll bar displayed on the touch screen 150 using a pen, the touch screen user interface triggers an old pen-move event to indicate that the scroll bar is moved to a position A and then triggers a new pen-move event to indicate that the scroll bar is further moved to a position B, where the old pen-move event and the new pen-move event containing independent position information respectively. For instance, the new pen-move event records information indicating the absolute position (e.g., B) instead of a relative displacement (e.g., B-A) between the new pen-move event and the old pen-move event. Under this discarding scheme, alleviating the command processing loads of the event controller 140 can be easily implemented by overriding the old pen-move event by the new pen-move event that further scrolls the scroll bar.

It should be noted the discarding mechanism can be activated in either or both of the event converter 110 and event controller 140, depending upon design requirements.

In addition, the event controller 140 further controls priorities assigned to the screen update commands translated from the pen events retrieved from the memory 124. In this way, the event controller 140 is capable of delaying the execution of screen update commands based on their priorities, where a screen update command with a high priority is assigned a short delay time, and a screen update command with a low priority is assigned a long delay time. Further description related to above operations is detailed as below.

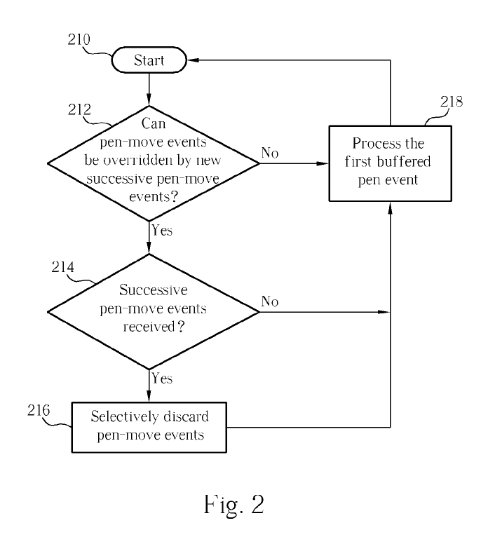

Please refer to FIG. 2. FIG. 2 is a flowchart showing a method for selectively discarding pen-move events (a specific form of the more generic touch screen events) according to an embodiment of the present invention. The event discarding mechanism performed by the event converter 110 or the event controller 140 is as below:

Step 210: Start.

Step 212: Can pen-move events be overridden by new successive pen-move events? If yes, continue to step 214. If no, go to step 218.

Step 214: Are there successive pen-move events received? If yes, continue to step 216. If no, go to step 218.

Step 216: Selectively discard pen-move events.

Step 218: Process the first buffered pen event then return to step 210.

In FIG. 2, it is illustrated that old pen-move events in the memory 124 can be overridden by new successive pen-move events. In other words, old pen-move events received by the event converter 110 can be safely discarded when there are also new successive pen-move events received by the event converter 110. For example, an old pen-move event that scrolls a scroll bar can be overridden by a new pen-move event that is received later. That is, the event converter 110 is designed to selectively discard some of the successive pen events that are triggered by the same interaction with the touch screen 150, such as scrolling the scroll bar.

However, in some cases such as handwriting recognition, old pen-move events can neither be overridden nor discarded due to the nature of processing handwriting recognition. The need for not discarding any pen events when performing handwriting recognition is well known and therefore additional details are omitted here for the sake of brevity.

In step 210 the process flow starts. In step 212, old pen events are checked by the event converter 110 to see if they can be overridden by new successive pen events given the current user interface scenarios (e.g., old pen-move events can not be discarded or overridden if the system is performing hand writing recognition). If pen-move events cannot be discarded then the process flows to step 218 and the event controller 140 processes the first pen event buffered in the memory 124 (e.g., a queue). Otherwise, the flow goes to step 214, and checks if there are successive pen-move events received at the event converter 110. If no successive pen-move events can be found then once again the flow returns to step 218. Otherwise, certain pen-move events are selectively discarded such that the number of pen-move events buffered in the event converter 110 is reduced. As a result, the event controller 140 merely translates the un-discarded pen events into corresponding screen update commands, and then controls the touch screen 150 using the screen update commands. With the help of the event discarding mechanism, the event controller 140 has fewer screen update commands to process, in fact, fewer overall loads, to process thereby improving the performance of the touch screen user interface controlling device 100. In this way, only the necessary pen events are ever buffered in the memory 124 and processed by the event controller 110.

Additionally, after pen events are buffered in the memory 124, the event controller 140 of the present invention can scan the received pen events to selectively discard pen events that are not necessary. For example, in a case where the event converter 110 merely stores all of the received pen events into entries of the memory 124, successive pen events trigged by the same interaction with the touch screen 150 are all buffered in the memory 124. Following the steps illustrated in FIG. 2, the event discarding mechanism is enabled at the event controller 140. Therefore, before translating the received pen even into a corresponding screen update command, the event controller 140 checks if the pen event can be overridden by a new pen event. As a result, in step 218 the event controller 140 only translates un-discarded pen events of the received pen events from the memory 124 into screen update commands. The same objective of reducing the processing load of the event controller 140, which might have weak computing power, is achieved. Please note that aforementioned exemplary embodiment of discarding pen-move events is only for illustrative purposes, and is not meant to be a limitation of the present invention.

In other words, in one embodiment, the present invention reduces the number of pen events entering the memory 124 by performing an examination upon the received pen events at the event converter 110; however, in another embodiment, the present invention reduces the number of pen events translated into screen update commands by performing an examination upon the received pen events at the event controller 140. In short, pen events can be discarded by the nature of their function, for example, pen events that are successive pen-move events generated in response to the same interaction with the touch screen user interface (e.g., scrolling the same scroll bar continuously), are deemed as discardable when possible according to the present mode of the operation of the touch screen 150 (e.g., window moving, scrolling). Since the screen update commands are generated according to available pen events, the event discarding mechanism implemented in the event converter 110 and/or the event controller 140 is able to improve the responsiveness of the touch screen user interface.

If the selective discarding of pen events is adopted, additional methods are also possible for further reducing the processing to maintain a highly responsive user interface being displayed on the touch screen 150. However, the present invention is not limited to adopt these disclosed methods simultaneously, and any touch screen user interface controlling device using one of the disclosed methods is able to improve responsiveness of the touch screen 150. Additional methods are described in the various following embodiments.

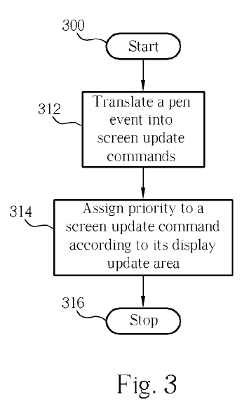

Please refer to FIG. 3. FIG. 3 is a flowchart showing a method for assigning priorities to screen update commands according to an embodiment of the present invention. When translating pen events into screen update commands, the event controller 110 further controls the priorities assigned to the screen update commands to be executed. The flow of assigning the priority is as below:

Step 300: Start.

Step 312: Translate a pen event into screen update commands.

Step 314: Assign priority to a screen update command according to its display update area.

Step 316: Stop.

In step 300 the process flow beings. In step 312, pen events that are triggered by interaction with the touch screen 150 and are not discarded if the above-mentioned event discarding mechanism is activated are then converted into corresponding screen update commands. According to the embodiment of the present invention, various priorities are assigned to the screen update commands to control the command execution order. In step 314, various priorities are assigned to different screen update commands such that a screen update command that has been assigned with a high priority will execute sooner than a screen update command that has been assigned with a low priority. In this embodiment, screen update commands corresponding to display areas of the touch screen 150 that are in the proximity of the pen position on the touch screen 150 are given higher priorities than those that are not within a predetermined proximity to the pen location on the touch screen 150. This is because the user will typically focus their viewing attention on the area that is near the current pen location on the touch screen 150. Therefore, the user will readily notice any slight delay in the processing of pen events in the area where their attention is focused. Therefore, the event controller 110 assigns each of the screen update commands a priority according to a proximity measurement, and then executes these screen update commands according priorities. In this way, the screen update commands used for updating display of areas near the pen position are quickly processed by the event controller 140 due to high priorities. Finally, in step 316, the flow stops. It should be noted that additional priority assignment rules are possible. For example, a screen update command corresponding to a movable user interface element (e.g., a scroll bar) is assigned with a priority higher than a screen update command corresponding to a non-movable user interface element (e.g., a button or a display area associated with a scroll bar).

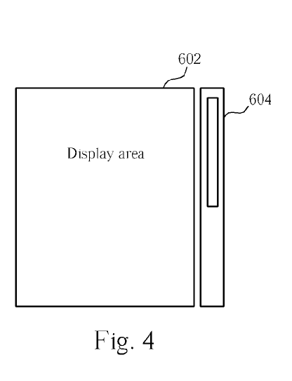

Please refer to FIG. 4. FIG. 4 is a diagram illustrating a scroll bar 604 and a display area 602 controlled by the scroll bar 604. FIG. 4 helps to illustrate a location and a location proximity that would be considered when applying the concept of assigning priorities to screen update commands as described earlier in reference to FIG. 3. Obviously many user interface elements can be equally appropriate for providing an example and the use of the scroll bar is offered as an example only and does not represent a limitation of the present invention. As shown in FIG. 4, FIG. 4 shows a user interface element, specifically, a scroll bar area, which is a good example of an area of the user interface where screen update commands for updating display of the scroll bar 604 would be assigned high priorities. This is necessary because the user's attention will be focused on the area of the scroll bar 604 as it is the active element of the user interface (i.e., when in use).

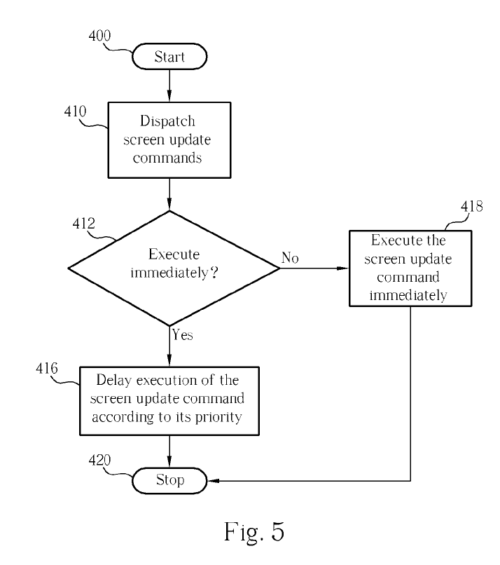

Please refer to FIG. 5. FIG. 5 is a flowchart showing a method for delaying screen update commands based on priorities assigned to said screen update commands according to an embodiment of the present invention.

Step 400: Start.

Step 410: Dispatch screen update commands (e.g., queue the screen update commands to be processed by the event controller 140 shown in FIG. 1).

Step 412: Execute a screen update command immediately? If yes, go to step 418. If no, go to step 416.

Step 416: Delay the execution of the screen update command according to its priority. Go to step 420.

Step 418: Execute the screen update command immediately.

Step 420: Stop.

According to this embodiment of the present invention, screen update commands to be processed are further delayed by the event controller 140 according to their corresponding assigned priorities if these screen update commands are not required to be executed immediately. In other words, screen update commands can be executed immediately or can be delayed for execution later. High priority screen update commands have a shorter delay while low priority screen update commands have a longer delay time.

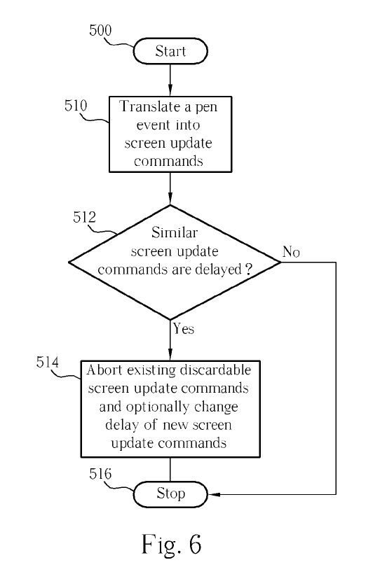

Please refer to FIG. 6. FIG. 6 is a flowchart showing a method for aborting existing discardable screen update commands based on new screen update commands generated in response to the same interaction with the touch screen user interface (e.g., scrolling the same scroll bar continuously) according to an embodiment of the present invention.

Step 500: Start.

Step 510: Translate a pen event into screen update commands.

Step 512: Are similar screen update commands already being delayed? If yes, go to step 514. If no, go to step 516.

Step 514: Abort the existing discardable screen update commands and optionally, change the delay of the new screen update commands.

Step 516: Stop.

According to this embodiment of the present invention, old screen update commands, which have been delayed for execution, are aborted by the event controller 140 when new (i.e., more recent) screen update commands of the same type are generated. Based on the implementation, it is possible to delay (or not delay) the newly generated screen update commands that caused the existing screen update commands to be discarded/aborted.

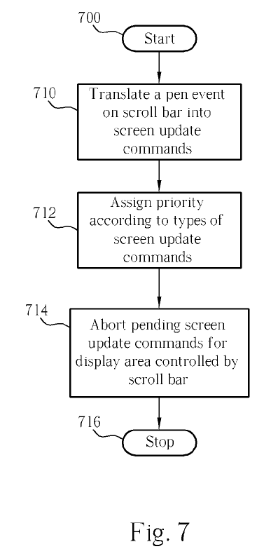

Please refer to FIG. 7. FIG. 7 is a flowchart showing a method for aborting existing screen update commands based on proximity according to an embodiment of the present invention.

Step 700: Start.

Step 710: Translate a pen event on a scroll bar into screen update commands.

Step 712: Assign priorities to the screen update commands according to the types of screen update commands.

Step 714: Abort old pending screen update commands for the display area controlled by the scroll bar (i.e., the portion of the user interface being displayed on the touch screen 150 that is controlled by the scroll bar).

Step 716: Stop.

In the flow above, screen update commands are generated by the user utilizing the scroll bar 604 shown in FIG. 4. In fact, the user manipulates the scroll bar 604 by way of one or more pen events. The pen events are later converted to corresponding screen update commands. Typically, screen update commands associated with a scroll bar 604 will be assigned a higher priority than those screen update commands that are associated with a display area 602 that is controlled by the scroll bar 604. As a result, each time that the scroll bar 604 is controlled by pen events to scroll, the scroll bar 604 can be redrawn immediately (i.e., the user interface element being the scroll bar 604 is immediately refreshed on the touch screen 150 display of the user interface). However, the display area 602 can be redrawn less frequently and this is accomplished because some of the screen update commands related to the updating of the display area 602 will be aborted when the scroll bar 604 is being scrolled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a touch screen user interface, the method comprising:
receiving a plurality of touch screen events;
selectively discarding at least one of successive discardable touch screen events of the touch screen events;
translating non-discarded touch screen events into a plurality of screen update commands; and
processing the screen update commands to control the touch screen user interface.

2. The method of claim 1, wherein all of the successive discardable touch screen events in the touch screen events generated from the touch screen user interface are independent events.

3. The method of claim 1, wherein the successive discardable touch screen events are pen-move events.

4. The method of claim 1, further comprising:
assigning each of the screen update commands a priority according to a user interface element displayed on the touch screen user interface.

5. The method of claim 4, wherein a screen update command corresponding to a movable user interface element is assigned with a priority higher than a screen update command corresponding to a non-movable user interface element.

6. The method of claim 5, wherein the non-movable user interface element is controlled by the movable user interface element, and the step of processing the screen update commands to control the touch screen user interface comprises:
aborting the processing of the screen update command corresponding to the non-movable user interface element when the screen update command corresponding to the movable user interface element is processed.

7. The method of claim 6, wherein the movable user interface element is a scroll bar, and the non-movable user interface element is a display area associated with the scroll bar.

8. The method of claim 4, wherein the step of assigning a priority to each of the screen update commands comprises:
assigning each of the screen update commands a priority according to the proximity of a current screen position of a touch screen event associated with the screen update command;
wherein a user interface element displayed on the touch screen user interface will be updated according to the screen update command.

9. The method of claim 8, wherein a screen update command corresponding to a movable user interface element is assigned with a priority higher than a screen update command corresponding to a non-movable user interface element.

10. The method of claim 4, wherein the step of processing the screen update commands to control the touch screen user interface comprises:
delaying the processing of the screen update commands according to corresponding priorities.

11. The method of claim 10, wherein the step of processing the screen update commands to control the touch screen user interface further comprises:
aborting the processing of a delayed screen update command when a new screen update command of the same type is generated.

12. The method of claim 11, wherein the step of processing the screen update commands to control the touch screen user interface further comprises:
selectively changing a delay of the processing of the new screen update command.

13. The method of claim 1, wherein the touch screen events are pen-up events or pen-down events or pen-move events.

14. A method for controlling a touch screen user interface, the method comprising:
receiving a plurality of touch screen events;
translating the touch screen events into a plurality of screen update commands, and assigning each of the screen update commands a priority according to a user interface element displayed on the touch screen user interface; and
processing the screen update commands to control the touch screen user interface according to corresponding priorities.

15. The method of claim 14, wherein a screen update command corresponding to a movable user interface element is assigned with a priority higher than a screen update command corresponding to a non-movable user interface element.

16. The method of claim 15, wherein the non-movable user interface element is controlled by the movable user interface element, and the step of processing the screen update commands to control the touch screen user interface comprises:
aborting the processing of the screen update command corresponding to the non-movable user interface element when the screen update command corresponding to the movable user interface element is processed.

17. The method of claim 16, wherein the movable user interface element is a scroll bar, and the non-movable user interface element is a display area associated with the scroll bar.

18. The method of claim 14, wherein the step of assigning a priority to each of the screen update commands comprises:
assigning each of the screen update commands a priority according to the proximity of a current screen position of a touch screen event associated with the screen update command and a user interface element displayed on the touch screen user interface that will be updated according to the screen update command.

19. The method of claim 18, wherein a screen update command corresponding to a movable user interface element is assigned with a priority higher than a screen update command corresponding to a non-movable user interface element.

20. The method of claim 14, wherein the step of processing the screen update commands to control the touch screen user interface comprises:
delaying the processing of the screen update commands according to corresponding priorities.

21. The method of claim 20, wherein the step of processing the screen update commands to control the touch screen user interface further comprises:
aborting the processing of a delayed screen update command when a new screen update command of the same type is generated.

22. The method of claim 21, wherein the step of processing the screen update commands to control the touch screen user interface further comprises:
selectively changing a delay of the processing of the new screen update command.

23. A device for controlling a touch screen user interface, the device comprising:
an event converter for receiving a plurality of touch screen events and selectively discarding at least one of successive discardable touch screen events of the touch screen events;
a memory, coupled to the event converter, for buffering non-discarded touch screen events outputted from the event converter;
an event controller, coupled to the memory, for translating the non-discarded touch screen events into a plurality of screen update commands, and processing the screen update commands to control the touch screen user interface.

24. The device of claim 23, wherein all of the successive discardable touch screen events in the touch screen events generated from the touch screen user interface are independent events.

25. The device of claim 23, wherein the successive discardable touch screen events are pen-move events.

26. The device of claim 23, where the event controller further assigns each of the screen update commands a priority according to a user interface element displayed on the touch screen user interface.

27. The device of claim 26, wherein a screen update command corresponding to a movable user interface element is assigned with a priority higher than a screen update command corresponding to a non-movable user interface element.

28. The device of claim 27, wherein the non-movable user interface element is controlled by the movable user interface element, and the event controller further aborts the processing of the screen update command corresponding to the non-movable user interface element when the screen update command corresponding to the movable user interface element is processed.

29. The device of claim 28, wherein the movable user interface element is a scroll bar, and the non-movable user interface element is a display area associated with the scroll bar.

30. The device of claim 26, wherein the event controller assigns each of the screen update commands a priority according to the proximity of a current screen position of a touch screen event associated with the screen update command and a user interface element displayed on the touch screen user interface that will be updated according to the screen update command.

31. The device of claim 30, wherein a screen update command corresponding to a movable user interface element is assigned with a priority higher than a screen update command corresponding to a non-movable user interface element.

32. The device of claim 26, wherein the event controller further delays the processing of the screen update commands according to corresponding priorities.

33. The device of claim 32, wherein the event controller further aborts the processing of at least a delayed screen update command when a new screen update command of the same type is generated.

34. The device of claim 33, wherein the event controller further selectively changes a delay of the processing of the new screen update command.

35. The device of claim 26, wherein the touch screen events are pen-up events or pen-down events or pen-move events.

36. A device for controlling a touch screen user interface, the device comprising:
an event converter for receiving a plurality of touch screen events;
a memory, coupled to the event converter, for buffering the touch screen events outputted from the event converter; and
an event controller, coupled to the memory, for selectively discarding at least one of successive discardable touch screen events received from the memory, translating non-discarded touch screen events into a plurality of screen update commands, and processing the screen update commands to control the touch screen user interface.

37. The device of claim 36, wherein all of the successive discardable touch screen events in the touch screen events generated from the touch screen user interface are independent events.

38. The device of claim 36, wherein the successive discardable touch screen events are pen-move events.

39. The device of claim 36, wherein the event controller further assigns each of the screen update commands a priority according to a user interface element displayed on the touch screen user interface.

40. The device of claim 39, wherein a screen update command corresponding to a movable user interface element is assigned with a priority higher than a screen update command corresponding to a non-movable user interface element.

41. The device of claim 40, wherein the non-movable user interface element is controlled by the movable user interface element, and the event controller further aborts the processing of the screen update command corresponding to the non-movable user interface element when the screen update command corresponding to the movable user interface element is processed.

42. The device of claim 41, wherein the movable user interface element is a scroll bar, and the non-movable user interface element is a display area associated with the scroll bar.

43. The device of claim 39, wherein the event controller assigns each of the screen update commands a priority according to the proximity of a current screen position of a touch screen event associated with the screen update command and a user interface element displayed on the touch screen user interface that will be updated according to the screen update command.

44. The device of claim 43, wherein a screen update command corresponding to a movable user interface element is assigned with a priority higher than a screen update command corresponding to a non-movable user interface element.

45. The device of claim 39, wherein the event controller further delays the processing of the screen update commands according to corresponding priorities.

46. The device of claim 45, wherein the event controller further aborts the processing of at least a delayed screen update command when a new screen update command of the same type is generated.

47. The device of claim 46, wherein the event controller further selectively changes a delay of the processing of the new screen update command.

48. The device of claim 36, wherein the touch screen events are pen-up events or pen-down events or pen-move events.

49. A device for controlling a touch screen user interface, the device comprising:
an event converter, for receiving a plurality of touch screen events;
a memory, coupled to the event converter, for buffering the touch screen events; and
an event controller, coupled to the memory, for translating the touch screen events into a plurality of screen update commands, assigning each of the screen update commands a priority according to a user interface element displayed on the touch screen user interface, and processing the screen update commands to control the touch screen user interface according to corresponding priorities.

50. The device of claim 49, wherein a screen update command corresponding to a movable user interface element is assigned with a priority higher than a screen update command corresponding to a non-movable user interface element.

51. The device of claim 49, wherein the event controller assigns each of the screen update commands a priority according to the proximity of a current screen position of a touch screen event associated with the screen update command and a user interface element displayed on the touch screen user interface that will be updated according to the screen update command.

52. The device of claim 51, wherein a screen update command corresponding to a movable user interface element is assigned with a priority higher than a screen update command corresponding to a non-movable user interface element.

53. The device of claim 52, wherein the non-movable user interface element is controlled by the movable user interface element, and the event controller further aborts the processing of the screen update command corresponding to the non-movable user interface element when the screen update command corresponding to the movable user interface element is processed.

54. The device of claim 53, wherein the movable user interface element is a scroll bar, and the non-movable user interface element is a display area associated with the scroll bar.

55. The device of claim 49, wherein the event controller further delays the processing of the screen update commands according to corresponding priorities.

56. The device of claim 55, wherein the event controller further aborts the processing of a delayed screen update command when a new screen update command of the same type is generated.

57. The device of claim 56, wherein the event controller further selectively changes a delay of the processing of the new screen update command.
